(19) United States
(12) Patent Application Publication
(10) Pub. No.: US 2026/0200309 A1
(43) Pub. Date: Jul. 16, 2026

(54) AERODYNAMIC RECIRCULATION DUCT TO PASS ATMOSPHERE AIR INTO THE RADIATOR AND CHARGE AIR COOLER

(71) Applicant: Volvo Truck Corporation, GÖTEBORG (SE)

(72) Inventors: Pavan ASHOK, Bengluru (IN); Michael BLACKABY, Greensboro, NC (US); Kiran GONA, Summerfield, NC (US)

(21) Appl. No.: 19/135,422

(22) PCT Filed: Dec. 5, 2022
(86) PCT No.: PCT/IB2022/061787

§ 371 Date: Jun. 4, 2025

(51) Int. Cl. B60K 11/08; B60K 11/04; F01P 5/06

(52) U.S. Cl. CPC B60K 11/08; B60K 11/04; F01P 5/06

(57) ABSTRACT

A recirculation duct to pass atmospheric temperature air into a cooling package (CP) having at least a radiator and a charger air cooler, the recirculation duct including a lower duct, a first side plate (SP), a second SP, and a center shield. The lower duct extends upstream from the CP and has a lower portion with a recirculation shield extending across a CP face. The first and the second SPs have a first end connected to a first end and a second end, respectively of the lower duct and extend along a first and second CP side, respectively. The center shield is connected at second ends of the first and second SPs and extends along a CP top. The recirculation and center shields and the first and second SPs inhibit air hotter than atmospheric temperature air from entering a CP intake duct.

### TECHNICAL FIELD

The disclosure relates generally to vehicle cooling systems. In particular aspects, the disclosure relates to an aerodynamic recirculation duct to pass atmosphere air into the radiator and charge air cooler. The disclosure can be applied in heavy-duty vehicles, such as trucks, buses, and construction equipment. Although the disclosure may be described with respect to a particular vehicle, the disclosure is not restricted to any particular vehicle.

### BACKGROUND

The properties of coolant and life of coolant in vehicle cooling systems can be negatively affected when hot air (e.g., air hotter than atmospheric temperature air) enters heat exchangers of vehicle cooling systems as coolant, particularly in warm climates. Additionally, dust enters into the vehicle cooling system, which in turn reduces the cooling system performance of the vehicle and can lead to premature failure of components.

### SUMMARY

According to a first aspect of the disclosure, a recirculation duct to pass atmosphere air into a cooling package of a vehicle (the cooling package having at least a radiator and a charger air cooler) includes a lower duct extending upstream from the cooling package, the lower duct having a lower portion with a recirculation shield extending across a face of the cooling package, the recirculation shield inhibiting air hotter than atmospheric temperature air from a downstream side of the cooling package from entering an intake duct of the cooling package. The recirculation duct further includes a first side plate have a first end connected to a first end of the lower duct and extending along a first side of the cooling package to inhibit air hotter than atmospheric temperature air from the first side of the cooling package from entering the intake duct. The recirculation duct further includes a second side plate having a first end connected to a second end of the lower duct and extending along a second side of the cooling package to inhibit air hotter than atmospheric temperature air from the second side of the cooling package from entering the intake duct. The recirculation duct further includes a center shield connected to the first side plate at a second end of the first side plate and connected to the second side plate at a second end of the second side plate and extending along a top of the cooling package to inhibit air hotter than atmospheric temperature air from the top of the cooling package from entering the intake duct. The first aspect of the disclosure may seek to inhibit air hotter that atmospheric temperature air and dust from entering the intake duct of the cooling package. A technical benefit may include increasing the efficiency of the vehicle cooling system.

In some examples, the recirculation duct further includes a lower duct rubber seal attached along a first side of the lower duct and at the first end and the second end; a first rubber seal attached along a sealant area at the first end of the first side plate; and a second rubber seal attached along a sealant area at the first end of the second side plate. A technical benefit may include increasing the sealing of the recirculation duct to inhibit dust and air hotter that atmospheric air temperature from entering the intake duct of the cooling package, thereby increasing the efficiency of the vehicle cooling system.

In some examples, the recirculation shield seals a front hood of the vehicle, a bumper of the vehicle, and a front grille of the vehicle such that substantially all air entering to the radiator is of atmospheric air temperature. A technical benefit may include increasing the sealing of the recirculation duct to inhibit dust and air hotter that atmospheric air temperature from entering the intake duct of the cooling package, thereby increasing the efficiency of the vehicle cooling system.

In some examples, the first side plate is connected to the lower duct via a snap fitting, the second side plate is connected to the lower duct via a snap fitting, and the center shield is connected to the first side plate and the second side plat via a snap fitting. A technical benefit may include enabling assembly of the recirculation duct to be relatively simple and straightforward.

In some examples, the lower duct comprises rubber material connected to a plastic material and a portion of the first side plate and the second side plate comprises a rubber material connected to plastic material. A technical benefit may include providing flexibility of the recirculation duct.

In some examples, the first side plate and the second side plate have mounting holes for mounting a cross member to each of the first side plate and the second side plate to prevent the first side plate and the second side plate from moving. A technical benefit may include enabling the first side plate and the second side plate to be better secured to the cooling package

In some examples, the first side plate and the second side plate are mounted to a side of the cooling package at a location to minimize air hotter than atmospheric temperature air from entering into the cooling package. A technical benefit may include increasing the efficiency of the vehicle cooling system.

According to a second aspect of the disclosure, a cooling package for a vehicle includes a radiator having one or more fans. The cooling package further includes a charge air cooler, CAC. The cooling package further includes a recirculation duct. The recirculation duct includes a lower duct extending upstream from the radiator and CAC, the lower duct having a lower portion with a recirculation shield extending across a face of the cooling package, the recirculation shield inhibiting air hotter than atmospheric temperature air from a downstream side of the cooling package from entering an intake duct of the cooling package. The recirculation duct further includes a first side plate have a first end connected to a first end of the lower duct and extending along a first side of the cooling package to inhibit air hotter than atmospheric temperature air from the first side of the cooling package from entering the intake duct. The recirculation duct further includes a second side plate having a first end connected to a second end of the lower duct and extending along a second side of the cooling package to inhibit air hotter than atmospheric temperature air from the second side of the cooling package from entering the intake duct. The recirculation duct further includes a center shield connected to the first side plate at a second end of the first side plate and connected to the second side plate at a second end of the second side plate and extending along a top of the cooling package to inhibit air hotter than atmospheric temperature air from the top of the cooling package from entering the intake duct. The first aspect of the disclosure may seek to inhibit air hotter that atmospheric temperature air and dust from entering the intake duct of the cooling package. A technical benefit may include increasing the efficiency of the vehicle cooling system.

In some examples, the recirculation duct further includes a lower duct rubber seal attached along a first side of the lower duct and at the first end and the second end; a first rubber seal attached along a sealant area at the first end of the first side plate; and a second rubber seal attached along a sealant area at the first end of the second side plate. A technical benefit may include increasing the sealing of the recirculation duct to inhibit dust and air hotter that atmospheric air temperature from entering the intake duct of the cooling package, thereby increasing the efficiency of the vehicle cooling system.

In some examples, the recirculation duct seals a front hood of the vehicle, a bumper of the vehicle, and a front grille of the vehicle such that substantially all air entering to the radiator is of atmospheric air temperature. A technical benefit may include increasing the sealing of the recirculation duct to inhibit dust and air hotter that atmospheric air temperature from entering the intake duct of the cooling package, thereby increasing the efficiency of the vehicle cooling system.

In some examples, the first side plate is connected to the lower duct via a snap fitting, the second side plate is connected to the lower duct via a snap fitting, and the center shield is connected to the first side plate and the second side plat via a snap fitting. A technical benefit may include enabling assembly of the recirculation duct to be relatively simple and straightforward.

In some examples, the lower duct comprises rubber material connected to a plastic material and a portion of the first side plate and the second side plate comprises a rubber material connected to plastic material. A technical benefit may include providing flexibility of the recirculation duct.

In some examples, the first side plate and the second side plate have mounting holes for mounting a cross member to each of the first side plate and the second side plate to prevent the first side plate and the second side plate from moving. A technical benefit may include enabling the first side plate and the second side plate to be better secured to the cooling package

In some examples, the first side plate and the second side plate are mounted to a side of the cooling package at a location to minimize air hotter than atmospheric temperature air from entering into the cooling package. A technical benefit may include increasing the efficiency of the vehicle cooling system.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

The accompanying drawings, which are included to provide a further understanding of the disclosure and are incorporated in and constitute a part of this application, illustrate certain non-limiting embodiments of the disclosure.

FIG. 1 is an illustration of an example of a vehicle in which the recirculation duct may be implemented according to one example.

FIG. 2 is an example of a coolant system of a vehicle in which the recirculation duct may be implemented according to one example.

FIG. 3 is cross-sectional view of cooling package of a radiator and charge air cooler and the recirculation duct according to one example.

FIG. 4 is an isometric view of the recirculation duct connected to the cooling package according to one example.

FIGS. 5-8 are views of components of the recirculation duct according to one example.

FIG. 9 is a view of a snap fitting used according to one example.

FIG. 10 is another view of FIG. 4, according to another example.

### DETAILED DESCRIPTION

Aspects set forth below represent the necessary information to enable those skilled in the art to practice the disclosure.

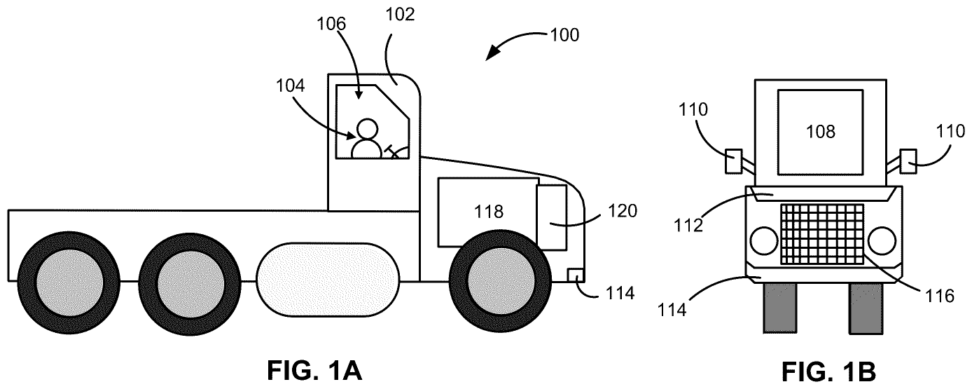

FIGS. 1A and 1B illustrate an exemplary environment in which the internal heat exchanger may operation according to one example. Turning to FIGS. 1A and 1B, a truck 100 having a cab 102 used by a vehicle user 104 sitting in the interior 106 of the cab is shown. The cab 106 has a windshield 108, outside rear view mirrors 110, front hood 112, bumper 114, and front grille 116. The vehicle has an engine 118 with cooling package 120.

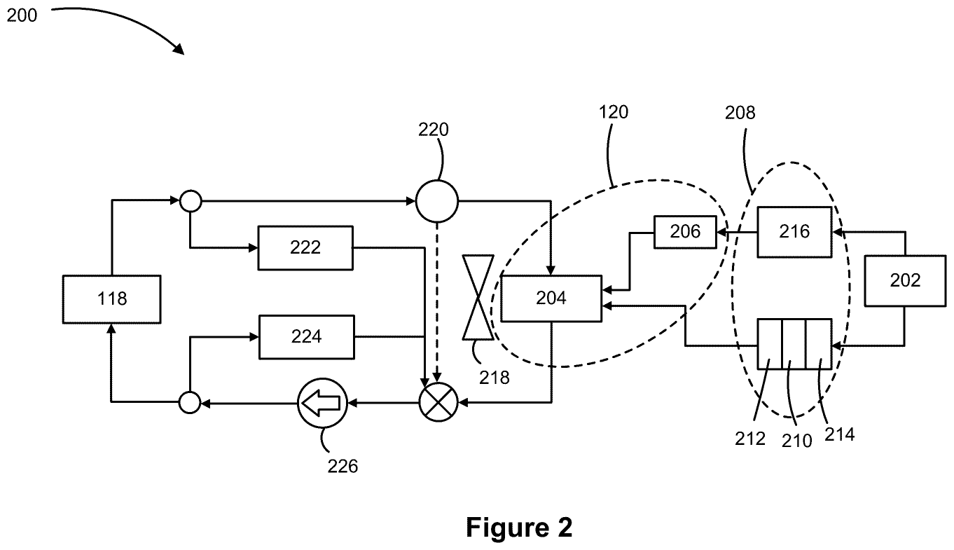

FIG. 2 is a schematic view of a coolant system 200 according to one example. Ambient air 202, also referred to herein as atmospheric temperature air 202, is directed to a cooling package 120 that includes a radiator 204 and charge air cooler, CAC, 206 by a recirculation duct 208 that includes a lower duct 210, a first side plate 212, a second side plate 214, and a center shield 216.

One or more fans 218 blow air through the radiator 204. Thermocouple 220 is used in controlling heaters 222 and coolers 224 to heat or cool coolant pumped by pump 226 through the engine 118.

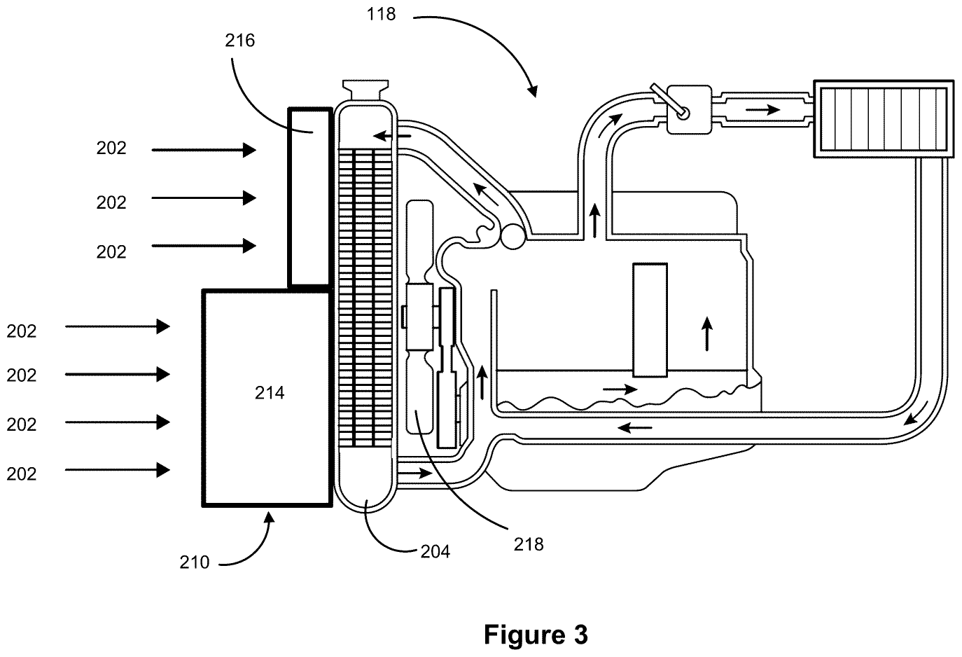

A cross sectional view of the engine and block diagram of the recirculation duct is illustrated in FIG. 3. The recirculation duct 208 inhibits hot air from the engine 118 and dust as illustrated by lower duct 210, side plate 214, and center shield 216.

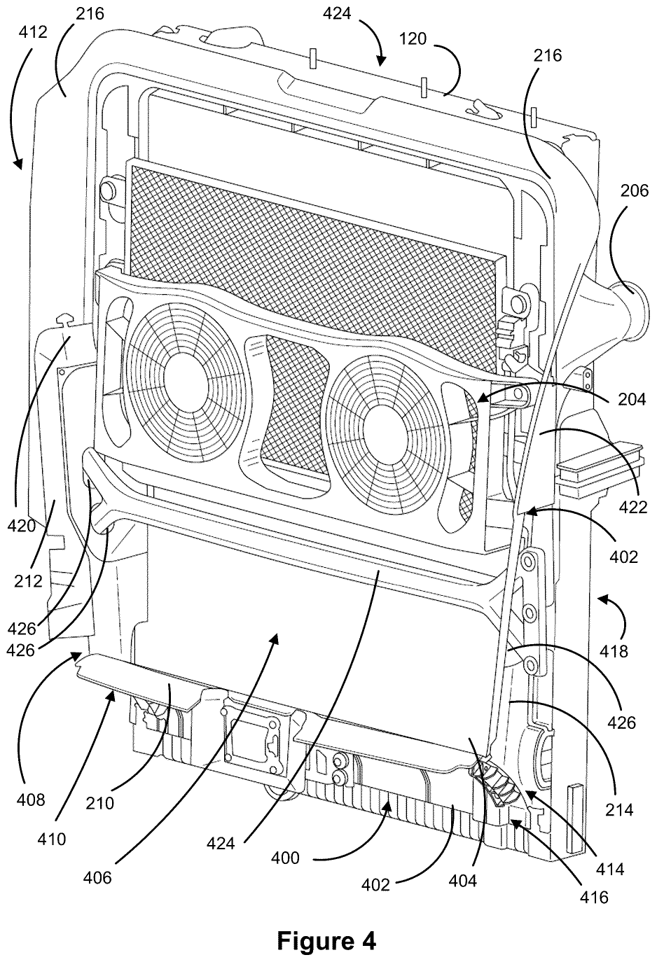

FIG. 4 illustrates the recirculation duct mounted to the cooling package 120. The lower duct 210 extends upstream from the cooling package 120. The lower duct has a lower portion 400 with a recirculation shield 402 extending across a face 404 of the cooling package 120, the recirculation shield 402 inhibiting air hotter than atmospheric temperature air from a downstream side of the cooling package 120 from entering an intake duct 406 of the cooling package 120. The recirculation shield 402 seals a front hood 112 of the vehicle 100, a bumper 114 of the vehicle 100, and a front grille 116 of the vehicle 100 such that substantially all air entering to the radiator 204 of the cooling package 120 is of atmospheric temperature air 202.

A first side plate 212 has a first end 408 connected to a first end 410 of the lower duct 210 and extending along a first side 412 of the cooling package 120 to inhibit air hotter than atmospheric temperature air from the first side 410 of the cooling package 120 from entering the intake duct 406 of the cooling package 120.

A second side plate 214 has a first end 414 connected to a second end 416 of the lower duct 210 and extends along a second side 418 of the cooling package 120 to inhibit air hotter than atmospheric temperature air from the second side 418 of the cooling package 120 from entering the intake duct 406 of the cooling package 120 (e.g., the intake duct of the radiator 206).

Thus, the first side plate 212 and the second side plate 214 are mounted to a side 412, 418 of the cooling package 120 at a location to minimize air hotter than atmospheric temperature air from entering into the cooling package.

The center shield 216 is connected to the first side plate 212 at a second end 420 of the first side plate 212 and connected to the second side plate 214 at a second end 422 of the second side plate 214 and extending along a top 424 of the cooling package 120 to inhibit air hotter than atmospheric temperature air from the top 424 of the cooling package 120 from entering the intake duct 406 of the cooling package 120.

The first side plate 212 and the second side plate 212 are held in place by a crossbar 426 placed through mounting holes 428 on each of the first side plate 212 and second side plate 214 and mounted to the cooling package 120. The second side plate 214 may have an additional mounting hole 430 to slide the second side plate 214 onto the second side 418 of the cooling package 120.

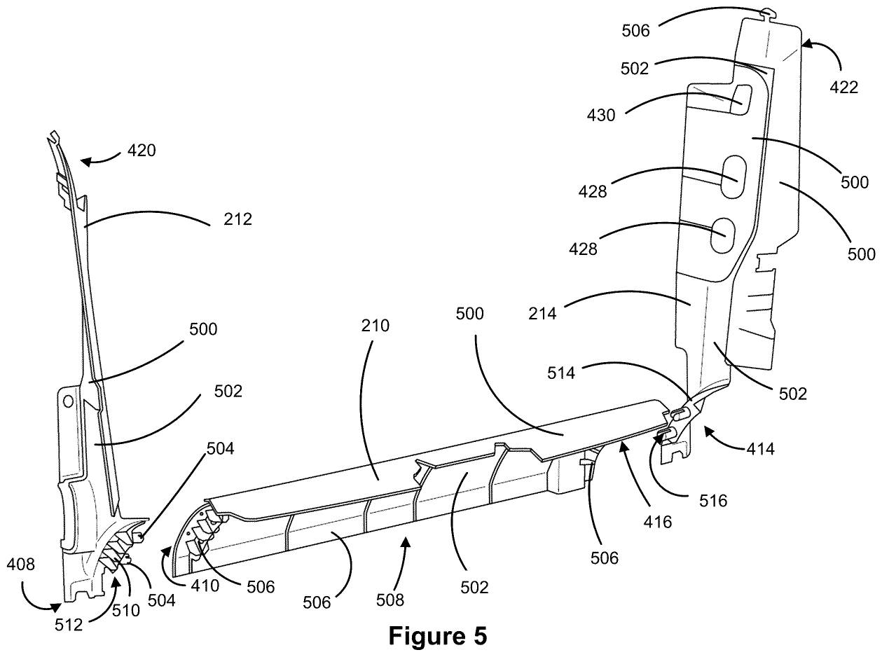

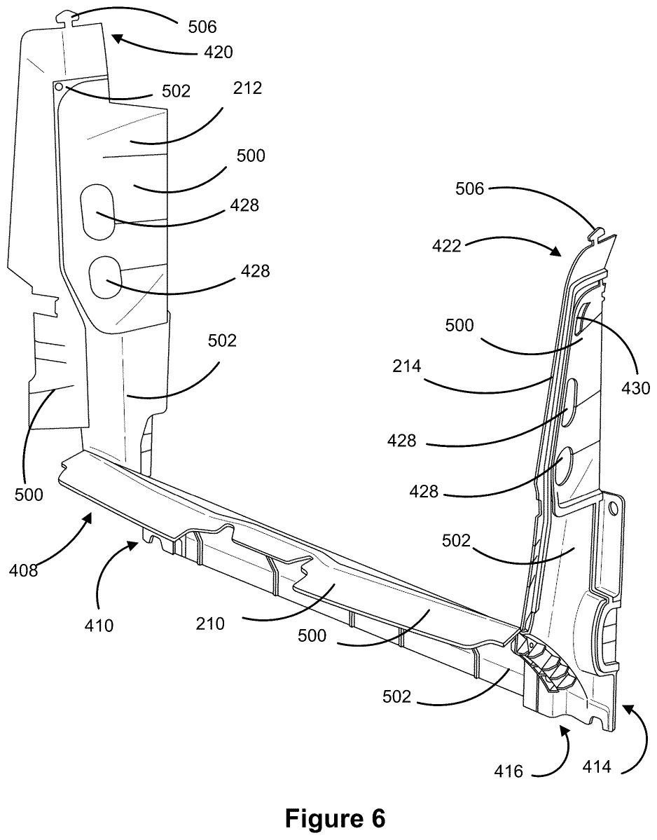

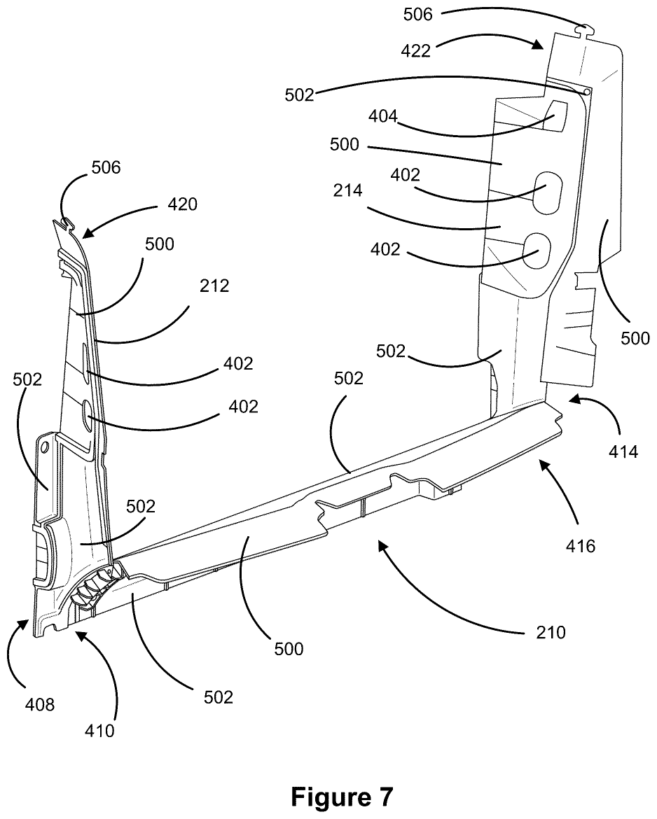

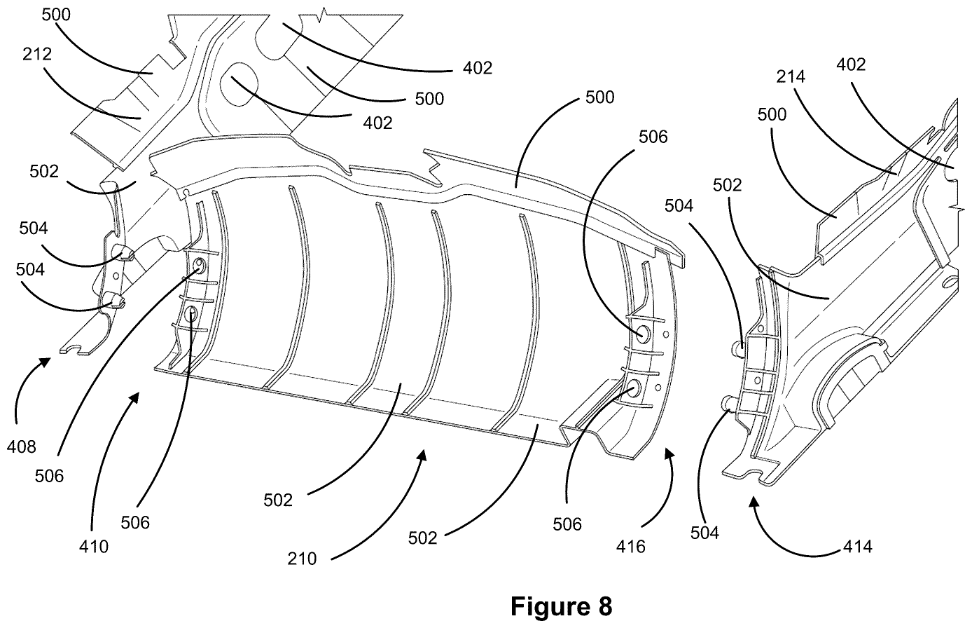

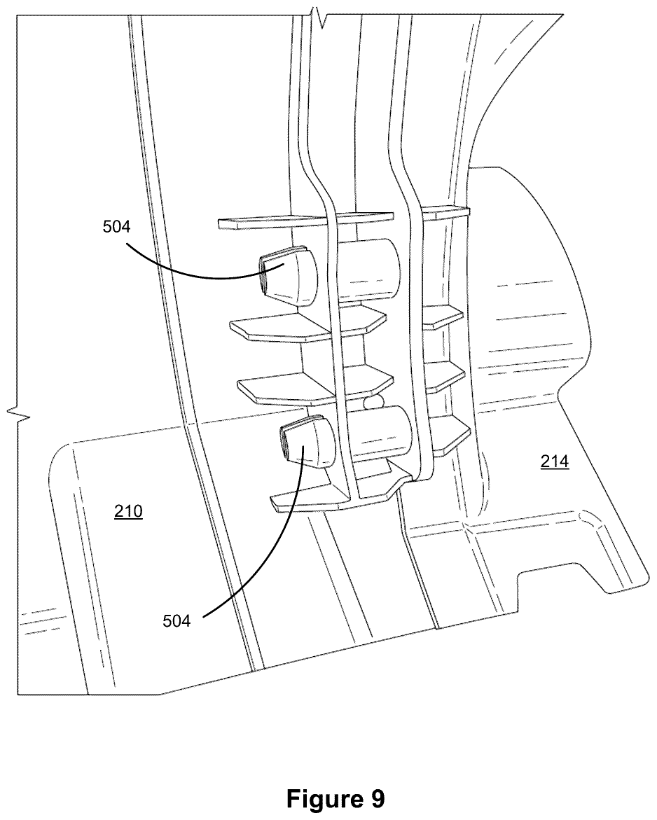

FIGS. 5-9 illustrate the lower duct 210, the first side plate 212 and the second side plate 214. Each of the lower duct 210, the first side plate 212 and the second side plate 214 are made of plastic material 500 and rubber material 502. The plastic material 500 of the lower duct 210 is shaped to enable sealing the front hood 112 of the vehicle 100, the bumper 114 of the vehicle 100, and the front grille 116 of the vehicle 100.

In one example, the rubber material 502 is added in an overmolding process. A press injects the polypropylene or other similar material for the plastic material 500, then opens and the part is rotated 180 degrees and the press closes again and the rubber material 502 is molded directly over the edge of the plastic material 500. Heat bonds the rubber material 502 and plastic material 500 together.

The center shield 216 may use a similar process. In one example, the center shield 216 incorporates three different materials, Nylon, polypropylene and santoprene (rubber). The nylon is molded separately, then the polypropylene is molded over it. Due to the very different melting points of the nylon and polypropylene, small oblong holes are located in the nylon. When the polypropylene is molded over the nylon, the plastic flows into these oblong slots to become one piece. Then the rubber is molded over the polypropylene.

The lower duct 210 is connected to the first side plate 212 and the second side plate 214 by snap fits. The first side plate 212 and the second side plate 214 have pins 504 that snap fit into receptacle holes 506 on the lower ducts 210. The center shield is connected to the first side plate 212 and the second side plate 214 by snap fits. The first side plate 212 and the second side plate 214 have tongues 508 that snap fit into receptacles in the center shield.

To help seal the lower duct 210 to the first side plate 212 and the second side plate 214, a lower duct rubber seal 510 is attached along a first side 512 of the lower duct 210 and at the first end 410 of the lower duct 210 and the second end 416 of the lower duct 210, a first rubber seal 514 is attached along a sealant area 516 at the first end 408 of the first side plate 212, and a second rubber seal 518 attached along a sealant area 520 at the first end 414 of the second side plate 214.

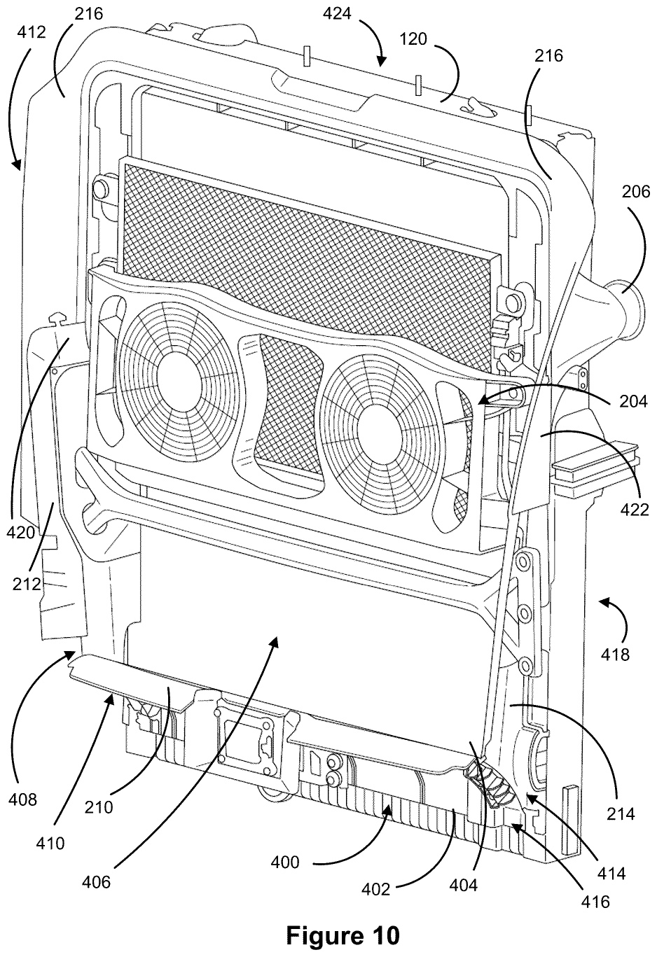

FIG. 10 is another view of FIG. 4, according to another example that illustrates a recirculation duct 208 to pass atmospheric temperature air 200 into a cooling package 120 of a vehicle 100, the cooling package 120 having at least a radiator 204 and a charger air cooler 206. The recirculation duct includes a lower duct 210 extending upstream from the cooling package 120, the lower duct 210 having a lower portion 400 with a recirculation shield 402 extending across a face 404 of the cooling package 120, the recirculation shield 402 inhibiting air hotter than atmospheric temperature air from a downstream side of the cooling package 120 from entering an intake duct 406 of the cooling package 120.

The recirculation duct further includes a first side plate 212 having a first end 408 connected to a first end 410 of the lower duct 210 and extending along a first side 412 of the cooling package 120 to inhibit air hotter than atmospheric temperature air from the first side 412 of the cooling package 120 from entering the intake duct 406 of the cooling package 120.

The recirculation shield further includes a second side plate 214 having a first end 414 connected to a second end 416 of the lower duct 210 and extending along a second side 418 of the cooling package 120 to inhibit air hotter than atmospheric temperature air from the second side 418 of the cooling package 120 from entering the intake duct 406 of the cooling package 120.

The recirculation shield further includes a center shield 216 connected to the first side plate 212 at a second end 420 of the first side plate 212 and connected to the second side plate 214 at a second end 422 of the second side plate 214 and extending along a top 424 of the cooling package 120 to inhibit air hotter than atmospheric temperature air from the top 424 of the cooling package 120 from entering the intake duct 406 of the cooling package 120.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A recirculation duct to pass atmospheric temperature air into a cooling package of a vehicle, the cooling package having at least a radiator and a charger air cooler, the recirculation duct comprising:
a lower duct extending upstream from the cooling package, the lower duct having a lower portion with a recirculation shield contacting the cooling package while extending across a face of the cooling package to inhibit air hotter than atmospheric temperature air from a downstream side of the cooling package from entering an intake duct of the cooling package;
a first side plate having a first end connected to a first end of the lower duct and contacting the cooling package while extending along a first side of the cooling package to inhibit air hotter than atmospheric temperature air from the first side of the cooling package from entering the intake duct of the cooling package;
a second side plate having a first end connected to a second end of the lower duct and contacting the cooling package while extending along a second side of the cooling package to inhibit air hotter than atmospheric temperature air from the second side of the cooling package from entering the intake duct of the cooling package; and
a center shield connected to the first side plate at a second end of 20 the first side plate and connected to the second side plate at a second end of the second side plate and contacting the cooling package while extending along a top of the cooling package to inhibit air hotter than atmospheric temperature air from the top of the cooling package from entering the intake duct of the cooling package.

2. The recirculation duct of claim 1, further comprising:
a lower duct rubber seal attached along a first side of the lower duct and at the first end of the lower duct and the second end of the lower duct;
a first rubber seal attached along a sealant area at the first end of the first side plate; and
a second rubber seal attached along a sealant area at the first end of the second side plate.

3. The recirculation duct of claim 1, wherein the recirculation shield seals a front hood of the vehicle, a bumper of the vehicle, and a front grille of the vehicle such that substantially all air entering to the radiator of the cooling package is of atmospheric temperature air.

4. The recirculation duct of claim 1, wherein the first side plate is connected to the lower duct via a snap fitting.

5. The recirculation duct of claim 1, wherein the second side plate is connected to the lower duct via a snap fitting.

6. The recirculation duct of claim 1, wherein the center shield is connected to the first side plate and the second side plate via a snap fitting.

7. The recirculation duct of claim 1, wherein the lower duct comprises rubber material connected to a plastic material.

8. The recirculation duct of claim 1, wherein a portion of the first side plate and the second side plate comprises a rubber material connected to plastic material.

9. The recirculation duct of claim 1, wherein the first side plate and the second side plate have mounting holes for mounting a cross member to each of the first side plate and the second side plate to prevent the first side plate and the second side plate from moving.

10. The recirculation duct of claim 1, wherein the first side plate and the second side plate are mounted to a side of the cooling package at a location to minimize air hotter than atmospheric temperature air from entering into the cooling package.

11. A cooling package for a vehicle comprising:
a radiator having one or more fans;
a charge air cooler, CAC; and
a recirculation duct comprising:
a lower duct extending upstream from the radiator and the CAC, the lower duct having a lower portion with a recirculation shield contacting the cooling package while extending across a face of the cooling package, to inhibit air hotter than atmospheric temperature air from a downstream side of the cooling package from entering an intake duct of the radiator;
a first side plate have a first end connected to a first end the lower duct and contacting the cooling package while extending along a first side of the cooling package to inhibit air hotter than atmospheric temperature air from 10 the first side of the cooling package from entering the intake duct of the radiator;
a second side plate having a first end connected to a second end of the lower duct and contacting the cooling package while extending along a second side of the cooling package to inhibit air hotter than atmospheric 15 temperature air from the second side of the cooling package from entering the intake duct of the radiator; and
a center shield connected to the first side plate at a second end of the first side plate and connected to the second side plate at a second end of the second side plate and contacting the cooling package while extending along a top of the cooling package to inhibit air hotter than atmospheric temperature air from the top of the cooling package from entering the intake duct of the radiator.

12. The cooling package of claim 11, wherein the recirculation duct further comprises:
a lower duct rubber seal attached along a first side of the lower duct and at the first end of the lower duct and the second end of the lower duct;
a first rubber seal attached along a sealant area at the first end of the first side plate; and
a second rubber seal attached along a sealant area at the first end of the second side plate.

13. The cooling package of claim 11, wherein the recirculation duct seals a front hood of the vehicle, a bumper of the vehicle, and a front grille of the vehicle such that substantially all air entering to the radiator is of atmospheric temperature air.

14. The cooling package of claim 11, wherein the first side plate is connected to the lower duct via a snap fitting.

15. The cooling package of claim 11, wherein the second side plate is connected to the lower duct via a snap fitting.

16. The cooling package of claim 11, wherein the center shield is connected to the first side plate and the second side plate via a snap fitting.

17. The cooling package of claim 11, wherein the lower duct comprises a rubber material and a plastic material.

18. The cooling package of claim 11, wherein a portion of the first side plate and the second side plate comprises a rubber material connected to plastic material.

19. The cooling package of claim 11, wherein the first side plate and the second side plate have mounting holes for mounting a cross member to each of the first side plate and the second side plate to prevent the first side plate and the second side plate from moving.

20. The cooling package of claim 11, wherein the first side plate and the second side plate are mounted to a side of the radiator at a location to minimize air hotter than atmospheric temperature air from entering into the radiator.
